(19) United States
(12) Patent Application Publication
(10) Pub. No.: US 2005/0084614 A1
(43) Pub. Date: Apr. 21, 2005

(54) Imbibing solutions, method of pretreating substrates with imbibing/coating solutions in preparation for digital printing, and substrates produced therefrom

(76) Inventors: Alison Salyer Bagwell, Cumming, GA (US); Jason Lye, Atlanta, GA (US)

Correspondence Address: KIMBERLY-CLARK WORLDWIDE, INC., 401 NORTH LAKE STREET, NEENAH, WI, 54956, US

(21) Appl. No.: 10/686,683

(22) Filed: Oct. 16, 2003

(51) Int. Cl. B05D 5/00

(52) U.S. Cl. 427/299; 427/372.2

(57) ABSTRACT

A method of producing a printed substrate so as to improve the adhesion, colorfastness and washfastness of ink jet inks including reactive and acid dye-based ink jet inks printed onto the substrate, the method includes the steps of providing a substrate, treating the substrate with an aqueous coating formulation comprising NMMO, a cationic polymer or copolymer, and a fabric softener, treating the substrate with an imbibing aqueous solution of either urea, and a component selected from sodium bicarbonate, sodium carbonate or combinations thereof, or ammonium salts of multifunctional weak acids, drying the substrate, printing on the substrate with an ink jet ink containing acid or reactive dye-based inks depending on the coating, and optionally post treating the printed substrate with a curing step.

### FIELD OF THE INVENTION

The present invention relates to substrates for digital printing and particularly, methods of treating substrates in preparation for ink jet printing, and the substrates produced by such methods. In particular, the present invention relates to imbibing solutions for use either alone or in conjunction with coating formulations, for treating textile substrates in preparation for ink jet printing, methods for treating the textiles, and articles produced therefrom. Such methods facilitate the use of such textiles in commonly available ink jet or laser printing devices, such as wide or narrow format ink jet and laser printers.

### BACKGROUND OF THE INVENTION

The ink jet method of printing is a rapidly growing, commercially important printing process because of its ability to produce economical, high quality, multi-colored prints. In fact, ink jet print methodology is becoming the print method of choice for producing colored hard copy of computer generated images consisting of graphics and fonts in both narrow and wide format. Ink jet printing is a non-impact and non-contact printing method in which an electronic signal controls and directs droplets or a stream of ink that can be deposited on a wide variety of substrates. Current ink jet printing technology involves forcing the ink drops through small nozzles by piezoelectric pressure, thermal ejection, or oscillation, and onto the surface of a material/print media (substrate). Ink jet printing is extremely versatile in terms of the variety of substrate material that can be treated, as well as the print quality and the speed of operation that can be achieved. In addition, ink jet printing is digitally controllable.

For these reasons, ink jet printing methodology has been widely adopted for industrial marking and labeling. In addition, ink jet printing methodology has also found widespread use in architectural and engineering design applications, medical imaging, office printing (of both text and graphics), geographical imaging systems (e.g., for seismic data analysis and mapping), signage, in display graphics (e.g., photographic reproduction, business and courtroom graphics, graphic arts), and the like. Finally, ink jet printing has now also been used to create an image on a variety of textile substrates such as cotton, silk and synthetic fabrics.

While a wide variety of textile fabrics have been heretofore used as substrates for ink jet printing, textile substrates have proven to be a challenge in this field since it is often difficult to print in such a manner that the ink penetrates either the interstitial spaces between, or within the fabric substrate fibers. Without the ability of ink to penetrate into these interstitial spaces, the printed image is less vivid and sometimes blurred. Therefore, there is a need for methods of pretreating fabric substrates which allows for the ink of an ink jet printer to penetrate the interstitial spaces in a fabric, eventually leading to a sharper print quality, and one that is more resistant to washout. There is also a need for fabric substrates produced by such pretreatment methods, which do not compromise “printability”. There is also a need for methods of treating such substrates that may be used on a variety of substrates.

Use of imbibing solutions with sodium bicarbonate, sodium carbonate and urea are known. Such imbibing solutions are typically used by textile mills in ink pastes along with other additives such as thickeners, and not in conjunction with coating treatments on the textile substrates themselves prior to being printed. The ink pastes are then rotary screen printed down onto the fabric substrates. With the use of such pastes in a conventional screen printing process, the process experiences a large amount of dye wash-off following printing.

Use of aqueous coating formulations and aqueous imbibing solutions with sodium bicarbonate, sodium carbonate and urea are also now known to be helpful in conjunction with aqueous textile coating formulations as pretreatments. See in this regard, WO 01/53107, WO 01/32974, and WO 02/66731 which are incorporated by reference hereto in their entirety. Despite the use of such coatings in order to enhance receptivity of a variety of inks to different substrates, there is still a need for coatings/imbibing solutions which encourage the interstitial spaces of such substrates to remain open, for greater depth of printing.

Finally, while the use of N-methylmorpholine-N-oxide (NMMO) as a cosolvent, is now known to improve the dye loading capabilities of ink jet inks themselves, such as described in U.S. Pat. Nos. 6,451,098 B1 and 6,596,066 B2 (which are each hereby incorporated by reference in their entirety), such material has not been associated with separate improved performance in fabric pre-treatments.

Accordingly, there is still a need in the art for ink jet printable substrate coatings/imbibing solutions and pretreatment methods, which provide for high optical density with a minimum amount of bleeding on the substrate during and after imaging from ink jet printers. There is also a need in the art for such ink jet printable substrate pretreatment methods which can be applied to a variety of textile fabric substrates. In this regard, there is still a need in the art for methods for treating fabrics for receiving ink-jet ink formulations, which methods allow for improved colorfastness and color intensity for multiple textile substrates. It is to such needs that the present invention is directed.

### SUMMARY OF THE INVENTION

In accordance with the present invention, it has been discovered that the color density and quality of the printed image, and the adhesion properties and/or colorfastness of ink jet inks and in particular, acid and reactive dye-based ink jet ink formulations, when applied to a variety of ink jet printable substrates, can be improved by pretreating the textile fabric substrates with coating formulations used in conjunction with imbibing solutions, containing N-methylmorpholine-N-oxide (NMMO).

In particular, a wide array of textile fabric substrates can be pre-treated to improve the colorfastness and washfastness of acid and reactive dye based ink jet ink formulations as well as other ink jet ink formulations. The treatment encompasses application of an aqueous pretreatment formulation including NMMO to a fabric substrate, prior to printing. The pretreatment may be part of a coating formulation (so as to include both a coating and imbibing formulation). Alternatively, such coating formulation may include NMMO but be applied with a separate imbibing formulation. Still further, such formulation may be part of a distinct imbibing solution that is separate from a coating formulation.

In one embodiment, the pretreatment formulation is part of an aqueous coating formulation (with both the coating and imbibing functionality contained in the one coating) that contains NMMO, and further includes a cationic polymer or copolymer and a fabric softener. In another embodiment, the coating formulation could further include urea.

In still a further embodiment, the pretreatment formulation is part of an aqueous coating formulation (with both the coating and imbibing functionality) that contains NMMO, and further includes a cationic polymer or copolymer, a fabric softener, urea and either sodium bicarbonate, sodium carbonate, or a combination thereof, the coating formulation designed to receive reactive dye based inks. Alternatively the aqueous formulation includes NMMO, the same cationic polymers and fabric softeners as previously described, but additionally urea and ammonium sulfate for receiving acid dye based inks. The NMMO may be present in the formulation in the form of solids (such as powder) or of an aqueous solution, such as a 50 percent aqueous solution.

In a particular embodiment, the aqueous coating combination formulation (containing both imbibing/coating pretreatments) includes between about 0.05-10% NMMO, between about 25-75% cationic polymers or copolymers, and between about 5-20% fabric softeners. Alternatively, the formulations may also include between about 0-50% by weight of a polymeric latex binder so as to increase washfastness. For the purposes of this application, these and the following percentages are representative of total solids percentages. Total solids content for the various formulations typically range from about 10-50%. In an alternative embodiment, the range of NMMO is between about 2 and 5 percent of the total solids. In still a further alternative embodiment, the range of NMMO is between about 4 and 5 percent of the total solids. In a further alternative embodiment, the range of cationic polymers is between about 25 and 40 percent of the total solids. In still a further alternative embodiment, the range of cationic polymers is between about 30 and 35 percent of the total solids. In still another alternative embodiment, the range of fabric softeners is between about 10 and 20 percent of the total solids. In still a further alternative embodiment, the range of fabric softeners is between about 10 and 15 percent of the total solids.

The substrate pretreatment formulations for acid or reactive dye based inks desirably include between about 0.05 and 7 percent urea. It should be noted that the term pretreatment is used herein to describe a treatment that is applied prior to printing with an ink jet ink. In some instances the pretreatment may be a coating that includes an imbibing solution. The coating is desirably applied to saturate the fibers of the fabric (such that it penetrates the interstitial spaces of the fibers). In an alternative embodiment, the formulations include between about 2 and 5 percent urea. In still a further alternative embodiment, the formulations include between about 3.5 and 4.75 percent urea.

In the case of substrate pretreatment formulations for acid dye based inks, it is desirable that ammonium sulfate be also present in a formulation of NMMO, cationic polymers, fabric softeners and urea, between about 0.1 and 10 percent of the total solids. In an alternative embodiment, it is desirable that the ammonium sulfate be present in an amount of between about 0.1 and 5 percent of the total solids. In still another alternative embodiment, it is desirable that the ammonium sulfate be present in an amount of between about 2 and 5 percent of the total solids.

In the case of substrate pretreatment formulations for reactive dye based inks, it is desirable that either sodium bicarbonate, sodium carbonate, or a combination thereof be present in the formulation between about 1 and 10 percent of the total solids. In an alternative embodiment, it is desirable that the sodium bicarbonate, sodium carbonate or combination be present in an amount of between about 2 and 5 percent of the total solids.

In still another alternate embodiment, use of aqueous cationic polymer coatings in conjunction with a separate aqueous imbibing solution of NMMO, urea and either sodium bicarbonate or sodium carbonate, for reactive dye classes, may be used. In still another alternate embodiment, use of aqueous cationic polymer coating formulations in conjunction with a separate aqueous imbibing solution of NMMO, ammonium sulfate and urea for acid dye classes may be used. In such separate imbibing formulations, it is desirable that the NMMO be present (in percent total solids) in a range from about 5 to 10 percent, and that the remaining components, be present in an amount of between about 90 and 95 percent. It should be recognized that in each of the above formulations, the NMMO may be present with water, so as to form an NMMO/water combination as previously described. The imbibing solutions may include further additives selected from the group including wetting agents, defoamers, and surfactants.

In still further alternative embodiments, the combination aqueous coatings include NMMO, a cationic polymer or copolymer, a fabric softener, urea and ammonium salts of multifunctional weak acids, selected from the group consisting of ammonium oxalate and ammonium tartrate. In still a further alternate embodiment, the coating formulation includes a tanning agent, such as ethylene glycol monoethyl ether, thiodiethylene glycol or a combination thereof. It should be understood that when the term “combination coating” is utilized in this application, it refers to a coating that includes within one formula a coating and imbibing functionality.

Similarly, in a further alternative embodiment, a distinct imbibing solution may include NMMO, ammonium salts of multifunctional weak acids, selected from the group consisting of ammonium oxalate and ammonium tartrate, and urea. In one embodiment, an aqueous imbibing solution, for enhancing image visualization and retention of acid dye-based inks includes NMMO, ammonium oxalate, and urea.

In still a further alternative embodiment, the aqueous coating formulation may itself include NMMO, but rely on a separate imbibing solution directed to either reactive or acid dyes. In such an embodiment, the aqueous coating would include NMMO, cationic polymers or copolymers and fabric softeners in percentages similar to those previously described. In still a further alternative embodiment, the invention contemplates fabrics treated with any of the above NMMO formulations.

In still a further embodiment, a method of treating a substrate so as to improve the adhesion, colorfastness and washfastness of an ink jet ink printed onto the substrate, and which substrate may be exposed to a post-treatment step following printing, includes the steps of providing a substrate, and pretreating the substrate with an aqueous coating or imbibing formulation comprising NMMO prior to printing.

In still a further alternative embodiment, a method of treating a substrate so as to improve the adhesion, colorfastness and washfastness of an ink jet ink printed onto the substrate, and which substrate may be exposed to a post-treatment step following printing, includes the steps of providing a substrate, pretreating the substrate with an aqueous coating formulation comprising NMMO, a cationic polymer or copolymer, a fabric softener, and urea.

In still a further embodiment, a method of treating a substrate so as to improve the adhesion, colorfastness and washfastness of an acid dye-based ink jet ink printed onto the substrate, and which substrate may be exposed to a post-treatment step following printing, includes the steps of providing a substrate, pretreating the substrate with an aqueous combination coating formulation comprising NMMO, a cationic polymer or copolymer, a fabric softener, urea, and ammonium sulfate. In a further alternative embodiment, the aqueous coating formulation previously described includes either ammonium oxalate or ammonium tartrate rather than ammonium sulfate (an ammonium salt of a multifunctional weak acid).

In still another alternative embodiment, a method of producing a printed substrate so as to improve the adhesion, colorfastness and washfastness of an acid dye-based ink jet ink printed onto the substrate, includes the steps of providing a substrate, treating the substrate with an aqueous combination coating formulation comprising NMMO, a cationic polymer or copolymer, a fabric softener, urea, either ammonium sulfate, oxalate or tartrate, drying the substrate, printing on the substrate with an acid dye-based ink, and optionally post-treating the printed substrate of the prior step. Such a post treatment step may encompass a curing step such as steaming the printed substrate.

In still another embodiment, a method of treating a substrate so as to improve the adhesion, colorfastness and washfastness of a reactive dye-based ink jet ink printed onto the substrate, and which substrate may be exposed to a post-treatment step following printing, includes the steps of providing a substrate, pretreating the substrate with an aqueous combination coating formulation comprising NMMO, a cationic polymer or copolymer, a fabric softener, urea, and either sodium bicarbonate, sodium carbonate or combination thereof.

In still another alternative embodiment, a method of producing a printed substrate so as to improve the adhesion, colorfastness and washfastness of a reactive dye-based ink jet ink printed onto the substrate, includes the steps of providing a substrate, pretreating the substrate with an aqueous combination coating formulation comprising NMMO, a cationic polymer or copolymer, a fabric softener, urea, either sodium bicarbonate, sodium carbonate or combination, drying the substrate, printing on the substrate with a reactive dye-based ink, post-treating the printed substrate of the prior step. Such a post treatment step may encompass steaming the printed substrate.

It is also contemplated that substrates treated by the above methods and printed articles produced by the above methods are also considered further alternative embodiments within this application.

The methods provide pathways to the fixation of dyes, irrespective of chemical class or textile fabric substrate, although their application to cellulose-based substrates such as cotton, rayon and linen is particularly useful. The methods are also particularly useful for preparing fabrics for receiving acid and reactive dye-based ink jet inks. Such methods do so with reduced need for any further ink curing process beyond drying under ambient conditions. In addition, efficacy of post printing processes such as steaming or curing may be enhanced by such formulations, reducing dye waste and further enhancing color vibrancy. Finally, fixation of pigment or other colorant may be enhanced by these formulations.

These and other features and advantages of the present invention will become apparent after a review of the following detailed description of the disclosed embodiments and the appended claims.

### BRIEF DESCRIPTION OF THE DRAWINGS

FIG. 1 illustrates a schematic view of an exemplary dip and squeeze process for treating ink jet printable textile substrates in accordance with the invention.

### DETAILED DESCRIPTION OF THE INVENTION

In accordance with the present invention, there are provided aqueous coatings/imbibing combination formulations including NMMO (such combination formulations having both coating and imbibing solution functionality), separate aqueous coatings including NMMO, separate aqueous imbibing solutions including NMMO, methods to improve the adhesion properties and/or colorfastness/color density and washfastness of ink jet printable substrates without the need of a heating or post treatment curing step, and methods of printing articles including pre-treating a textile substrate with an aqueous coating formulation including NMMO, cationic polymers or copolymers and fabric softeners. Each of the methods involves pre-treating a fabric substrate with an aqueous formulation including NMMO, prior to printing.

In particular, the combination coating formulation (containing both imbibing/coating pretreatment components) desirably includes between about 0.05-10 percent (of total solids) NMMO, between about 25-75 percent of total solids cationic polymers or copolymers, and between about 5-20 percent of total solids fabric softeners. Alternatively, the formulations may also include between about 0-50 percent of total solids of a polymeric latex binder so as to increase washfastness. These percentages are based on total solids. Total solids content for the formulations typically range from about 10-50%. As an example, if the percent of NMMO is about 10 percent of the total solids, and the total solids of the formulation was 50 percent, the total solids percentage of NMMO in the formulation would be about 5 percent. For the purposes of this application, the percent of the total solids is calculated by dividing the dry parts value for a particular component by the total dry parts of all of the components of the formulation. To analyze total solids in solution, one would use a total solids analyzer, as is commonly available in the analytical art.

In an alternative embodiment, the range of NMMO is between about 2 and 5 percent of the total solids. In still a further alternative embodiment, the range of NMMO is between about 4 and 5 percent of the total solids. In a further alternative embodiment, the range of cationic polymers is between about 25 and 40 percent of the total solids. In still a further alternative embodiment, the range of cationic polymers is between about 30 and 35 percent of the total solids. In another alternative embodiment, the range of fabric softeners is between about 10 and 20 percent of the total solids. In still another alternative embodiment, the range of fabric softeners is between about 10 and 15 percent of the total solids.

The combination coating pretreatment formulations for substrates to be printed with acid and reactive dye class inks desirably include between about 0.05 and 7 percent urea. In an alternative embodiment, the formulations include between about 2 and 5 percent urea. In still a further alternative embodiment, the formulations include between about 3.5 and 4.75 percent urea.

In the case of reactive dye class ink (receptive) combination coating formulations, it is desirable that either sodium bicarbonate, sodium carbonate, or a combination thereof be present in the formulation between about 1 and 10 percent of the total solids. In an alternative embodiment, it is desirable that the sodium bicarbonate, sodium carbonate or combination be present in an amount of between about 2 and 5 percent of the total solids.

In the case of acid dye class ink (receptive) combination coating formulations, it is desirable that ammonium sulfate be present in the formulation between about 0.1 and 10 percent of the total solids. In an alternative embodiment, it is desirable that the ammonium sulfate be present in an amount of between about 0.1 and 5 percent of the total solids. In an alternative embodiment, it is desirable that the ammonium sulfate be present in an amount of between about 2 and 5 percent of the total solids.

In another alternate embodiment, use of the aqueous cationic polymer coatings in conjunction with a separate imbibing solution of either NMMO, urea and either sodium bicarbonate or sodium carbonate, for reactive dye classes, may be used. In still another alternate embodiment, use of aqueous cationic polymer coating formulations in conjunction with a separate aqueous imbibing solution of NMMO, ammonium sulfate and urea for acid dye classes may be used. In such separate imbibing formulations, it is desirable that the NMMO be present in a range from about 5 to 10 percent of the total solids in the imbibing formulation, and that the remaining components, be present in an amount of between about 90 and 95 percent of the total solids. It should be recognized that in each of the above formulations, the NMMO may be present with water solution, so as to create an NMMO/water combination as previously described.

In still further alternative embodiments, the combination aqueous coatings/imbibing solutions include NMMO, a cationic polymer or copolymer, a fabric softener, urea and ammonium salts of multifunctional weak acids, selected from the group consisting of ammonium sulfate, ammonium oxalate and ammonium tartrate. In still a further alternate embodiment, the coating formulation includes a tanning agent, such as ethylene glycol monoethyl ether, thiodiethylene glycol or a combination thereof.

Similarly, in a further alternative embodiment, a distinct imbibing solution may include NMMO, urea and ammonium salts of multifunctional weak acids, selected from the group consisting of ammonium sulfate, ammonium oxalate and ammonium tartrate. In one embodiment, an aqueous imbibing solution, for enhancing image visualization and retention of acid dye-based inks includes NMMO, ammonium oxalate, and urea.

In still a further alternative embodiment, the aqueous coating formulation may itself include NMMO, but rely on a separate imbibing solution directed to either reactive or acid dyes. In such an embodiment, the aqueous coating would include NMMO, cationic polymers or copolymers and fabric softeners in percentages similar to those previously described.

In still another embodiment, a method of treating a substrate so as to improve the adhesion, colorfastness and washfastness of an acid dye-based ink jet ink printed onto the substrate, and which substrate may be exposed to a post-treatment step following printing, includes the steps of providing a substrate, treating the substrate with an aqueous coating formulation comprising NMMO, a cationic polymer or copolymer, a fabric softener, urea, and ammonium sulfate. In a further alternative embodiment, the aqueous coating formulation includes either ammonium oxalate or ammonium tartrate rather than ammonium sulfate.

In still another alternative embodiment, a method of producing a printed substrate so as to improve the adhesion, colorfastness and washfastness of an acid dye-based ink jet ink printed onto the substrate, includes the steps of providing a substrate, treating the substrate with an aqueous coating formulation comprising NMMO, a cationic polymer or copolymer, a fabric softener, urea, and either ammonium sulfate, oxalate or tartrate, drying the substrate, printing on the substrate with an acid dye-based ink, and post-treating the printed substrate of the prior step.

In still another embodiment, a method of treating a substrate so as to improve the adhesion, colorfastness and washfastness of a reactive dye-based ink jet ink printed onto the substrate, and which substrate may be exposed to a post-treatment step following printing, includes the steps of providing a substrate, pretreating the substrate with an aqueous coating formulation comprising NMMO, a cationic polymer or copolymer, a fabric softener, urea, and either sodium bicarbonate, sodium carbonate or combination thereof.

In still another alternative embodiment, a method of producing a printed substrate so as to improve the adhesion, colorfastness and washfastness of a reactive dye-based ink jet ink printed onto the substrate, includes the steps of providing a substrate, pretreating the substrate with an aqueous coating formulation comprising NMMO, a cationic polymer or copolymer, a fabric softener, urea, either sodium bicarbonate, sodium carbonate or combination, drying the substrate, printing on the substrate with a reactive dye-based ink, and post-treating the printed substrate of the prior step. Such a post treatment step may be accomplished by steaming.

In a desirable method, the method for coating a substrate comprises treating a textile substrate with an aqueous coating formulation including between about 1-10 percent NMMO, between about 25-75 percent cationic polymers or copolymers, and between about 5-20 percent fabric softeners. As has been stated earlier, these percentages are percent of total solids, unless otherwise stated.

The present invention is further directed to a treated ink jet printable substrate wherein the treatment comprises an aqueous coating formulation of NMMO, cationic polymers or copolymers and fabric softeners. A desirable embodiment of the present invention is a treated ink jet printable substrate wherein the aqueous coating treatment comprises between about 1-10 percent NMMO, between about 25-75 percent cationic polymers or copolymers, and between about 5-20 percent fabric softeners.

The fabric substrate pretreatment formulations include N-methylmorpholine-N-oxide as shown below. N-methylmorpholine-N-oxide (hereinafter NMMO) may be present in a 10 to 50% aqueous solution, prior to being placed in a pretreatment or coating formulation, but may alternatively be present in solid-powder form.

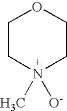

NMMO may be obtained from Aldrich Chemical Co. Inc., of Milwaukee, Wis. Other names for pure NMMO include CAS Registry number 7529-22-8,4-methylmorpholine 4-oxide, 4-methylmorpholine N-oxide, 4-methylmorpholine oxide, N-methylmorpholine N-oxide, and NMO. As NMMO strongly associates with water, it is often supplied in a hydrated form, for instance, as the disesquihydrate (CAS Registry 80913-65-1), N-methyl morpholine N-oxide hydrate (2:5), CAS registry number 172158-61-1 (Morpholine, 4-methyl-, 4-oxide, mixture with water), CAS registry number 80913-66-2 (a mixture of NMMO and water in an unspecified ratio), CAS registry number 70187-32-5 (4-methylmorpholine 4-oxide monohydrate), CAS registry number 85489-61-8 (N-methylmorpholine oxide dihydrate).

Since NMMO is not volatile, it remains in fabric substrates that are pretreated with it and dried. Since aqueous NMMO can be used as a solvent system for cellulose, it will likely swell cellulosic materials. Additionally, NMMO will swell other fibers as well. Such fibers may include wool, nylon and silk. It has been found that when a fabric substrate is imbibed with a solution containing NMMO and then dried, almost all of the NMMO and associated water remain behind in the fabric. Since the system is a solvent and has the ability to swell fibers, the fibers in the fabric remain in their swollen state. It has been found that in this swollen state, the fibers are more chemically reactive. Furthermore, the swollen state allows ink colorants to penetrate the fibers more readily, thereby leading to a more effective final print.

The presence of metal ions may cause undesirable reactions during drying, such as yellowing. In addition, free metal ions may cause undesirable color shifts of dyes applied to the fabric later, or even to any brightening agent already on the fiber. For this reason, a sequestering agent may optionally be added to sequester free metal ions that may otherwise take part in color shifting reactions. An example of such a sequestering agent includes ethylene diaminetetraacetic acid (EDTA) available as Versene 100XL (tetra sodium salt) from Dow Chemical of Midland, Mich.

The cationic polymers/copolymers function in the pretreatment formulation to attract and fix oppositely charged anionic dye molecules to the substrates, and in particular, textile fabric substrates. The polymers or copolymers may contain reactive residues or groups capable of crosslinking to the textile fibers, with themselves, or with other components present in the formulation. Such cationic resins may incorporate charge groups in the main polymer chains or polymer backbones, or as side groups in the polymer chains. Such polymers are described further in WO 01/32974 which is incorporated herein by reference in its entirety. The cationic polymers for use in the coatings may include but are not limited to, polymers and copolymers of diallyidialkyammonium monomers such as diallyldimethylammonium chloride, cationic acrylate and acrylamide such as acryloxyethyldimethylammonium chloride or acrylamidoethyldimethylammonium chloride monomers, quarternized vinylpyridine such as methyl vinylpyridine chloride, and polyalkylamine polymers and copolymers. Co-monomers in such systems may consist of ones which modify the flexibility, hydrophobicity, or mechanical properties of the polymer molecule. In addition, reactive and/or self-condensing monomers may be included to enhance adhesion to the textile fiber or other components in the formulation. Other examples of cationic polymers with charged groups in the main chain include epihalohydrin-amine polymers such as Reten™ 204 LS and Kymene™ 557 LX polymers of Hercules Incorporated, of Wilmington, Del. A specific example of desired cationic polymer resin is CP 7091 RV (7091 RV) available from Imerys of Roswell, Ga., with CP 7091 RV being a poly(diallyidimethlammonium chloride-co-diacetone acrylamide). Suitable fabric softeners which may be used in accordance with the present inventive coatings/imbibing solutions/methods include, but are not limited to, Varisoft 222 of the Witco Corporation of Greenwich, Conn., Adogen 432 also of the Witco Corporation, Accosoft 550-75 of the Stepan Company of Northfield, Ill., Alubrasoft Super 100 and Alubrasoft 116 of the BASF Corporation, Specialty Chemicals Division of Mt. Olive, N.J., and Ahcovel Base N-62 of ICI Surfactants or Hodgson Texiles Chemical of Mt. Holly, N.C. Suitable fabric softeners include those that are cationic or nonionic and provide the attributes of print quality and image brightness to the printed textile substrate. The fabric softener most suitable to a particular textile fabric substrate varies by fabric substrate. For instance, it has been found that the fabric softener Varisoft 222 (VS 222) performs better with colton-type fabric samples while Adogen 432 performs better with nylon/lycra fabric samples.

In another embodiment of the present invention, the previously described coating treatments or formulations for ink jet printable substrates also include a latex binder in order to further enhance the adhesion and/or waterfastness of colorants on the textile fabric substrates. It has been found that coated ink jet receptive substrates including a latex binder provide high color density and saturation, superior print quality, reduction of wicking or bleeding, and enhanced ink absorption. Furthermore, the coating or treatment formulations provide a waterfast printed image when printing via an ink jet printing process, without the necessity of post-printing curing steps such as heating, steaming, chemical fixation, or radiation. Likewise, the present invention is also directed to a treated ink jet printable substrate wherein the treatment comprises an aqueous coating formulation as previously described, and a latex binder.

The treatment or coating formulations in this alternate embodiment consist primarily of NMMO, cationic polymers and copolymers, fabric softeners and a water-insoluble polymer in the form of a latex dispersion or emulsion. In particular, the treating formulation may include about 0-50% polymeric latex binder depending on the textile fabric substrate. The latex reinforcing polymers may be either nonionic or cationic. By way of example only, the latex materials may include vinylacetate, ethylene-vinylacetate, acrylate, styrene, and styrene-acrylate resins and other cationic or nonionic latexes. These resins may include reactive or self cross-linking groups in addition to inherent cationic functionality. An example of suitable latex polymers include PrintRite 591 (PR 591) acrylic emulsion, from BF Goodrich and Airflex 540 (AF 540) latex emulsion (ethylene-vinyl acetate copolymer) of AirProducts and Chemicals Inc. of Allentown, Pa.

The aqueous coating/imbibing formulations may also include other additives which affect the appearance or tactile properties of the finished substrate, such as optical brighteners. Total solids content for the formulations typically range from about 5-50%, but desirably between about 10-50% and even more desirably between about 5-32%.

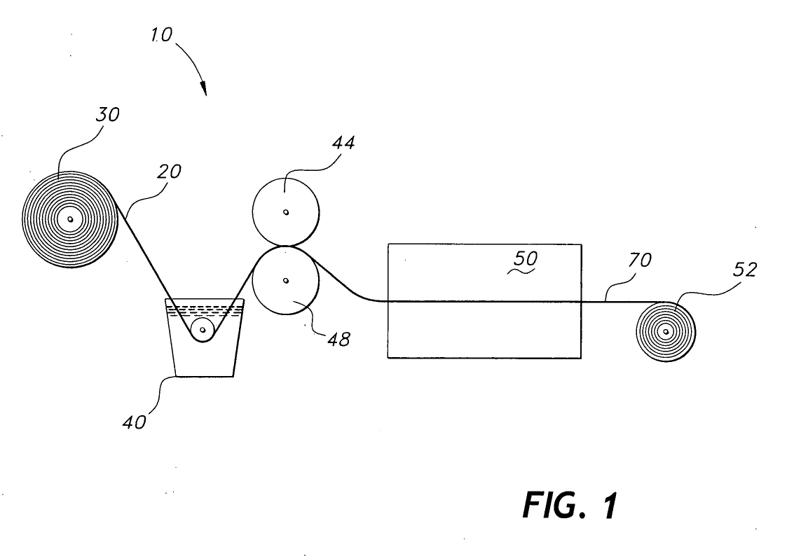

Treatment formulations (compositions) for the textile substrates are made by adding the above components from stock solutions or dispersions, or as solids where appropriate, and mixing to homogeneity. Application of the treatment formulation to the textile substrates may be carried out by any known means to those having ordinary skill in the art. For instance, fabric substrates may be treated by a standard padding (dip and squeeze) method and dried in a forced air oven, although any suitable drying means of textiles known to those skilled in the art may be employed. For a padding method, the formulation is padded on and then the excess is squeezed off through a nip roller. As can be seen in FIG. 1 showing a schematic view of a dip and squeeze process 10 for treating ink jet printable substrates, a textile substrate 20 is unwound from the incoming roll 30 and is then dipped in a saturator tank/bath 40 for sufficient time for it to become saturated with the treating formulation. The textile substrate is then run through a pressurized nip roll set 44 and 48. The pressure on the rolls should be in the range of about 10-120 psig but desirably in the range of about 10-65 psig, depending on the type of textile fabric substrate utilized, and the total solids content of the treatment formulations used. The pressurized nip rolls squeeze the coating evenly onto the substrate so as to penetrate the surface of the substrate. The rolls may be either rubber or steel, however a set of rolls in which at least one roll being rubber is desirable. Following passage through the nip pressure rolls, the textile substrate is coursed through a drying means 50. The drying means may include a tenter frame for holding the textile substrate, and may itself encompass multiple consecutive drying means depending on the nature of the substrate to be dried. The drying temperature is desirably in the range from between about 200° F. to 325° F., more desirably between about 2200 to 250° F. The typical time for drying is between about 30 seconds and 3 minutes. Following drying, the finished treated textile substrate is taken up on a wind up roll 52. The textile substrate may be rolled up for storage or moved to a second lamination process in preparation for ink jet printing. In this regard, the textile substrate may be laminated to a carrier backing for ease of printing, as described further below.

Using this application method, dry pick-up ratios of the textile substrate may vary from about 0.5% to about 50%. Desirably, the dry pick-up ratios may vary from about 3 to about 20%. More desirably, the dry pick-up ratios may vary from about 6 to about 15%. Wet pick-up ratios for the textile substrates are typically between about 30-150%. Desirably such wet pick-up ratios are between about 80-120%. These terms are defined by equations set forth later herein.

Substrates which may be treated in accordance with the present inventive methods are varied and include paper, fabric, nonwovens, films, and the like, although textile fabric substrates are preferred. Such fabrics may include cotton, silk, wool, polyester, rayon, nylon, and blends thereof. Furthermore, the disclosed ink jet substrates may provide the benefits disclosed herein with or without further post-printing curing steps (post treatment steps such as heating, steaming, and ironing for example) involving the use of heat, radiation or pressure. Ideally such treated substrates provide adhesion and/or colorfastness of the colorant with only ambient or room temperature curing or drying of the printed image. It should be noted however, that while not being necessary for the process, a post printing curing step may further enhance the colorfastness and washfastness of the printed image on the substrate. The basis weight of the various fabrics which may be treated by these formulations may range from about 2 ounces per square yard (osy) to about 9 osy.

Dye classes which may be used in ink jet printers to be printed on such substrates include acid dyes, reactive dyes, direct dyes, azoic dyes, sulfur dyes, modified dyes, polymeric dyes, copolymerized dyes or other classes of colorants known to those skilled in the art. Furthermore, pigment colorants may be used in the ink jet printers to be printed on such substrates. Additionally, it has been found that when such substrate is printed with ink jet inks containing additives, such as those described in U.S. Pat. No. 5,897,694 incorporated herein by reference in its entirety, such substrate treatments may be enhanced so as to provide enhanced colorfastness and washfastness. Additionally, inks including high dye loading solvents, such as those described in U.S. Pat. No. 6,451,098 may be used to further enhance color retention.

In accordance with yet another embodiment of the present invention, there are provided substrates and articles produced by the above described methods, employing treated textile substrates as described herein. Such articles may include for example banners, wall coverings and other home furnishing products. Thus according to the present invention, ink jet printed images applied to a treated substrate as described herein, resists removal of said image from said substrate, even upon repeated contact of the printed substrate with water. Such repetitive contact can be the result of normal handling of an article, accidental exposure to liquid, and routine laundering of the article. When articles according to the present invention comprise a treated substrate containing an ink jet image printed thereon, the resulting image adheres sufficiently to said substrate to resist removal therefrom upon washing of said article and demonstrates sharper imaging quality. The present invention is further described by the examples which follow. Such examples however, are not to be construed as limiting in any way either the spirit or the scope of the present invention.

### EXAMPLE 1

In a first example, the coating formulation of Table 1 below, was added to the cotton fabric as described below, and dried at 100° C. The fabric was then printed as described, and steamed and/or washed as noted below in the L*a*b* measurement descriptions.

TABLE 1

| Component | % total solids | Dry Parts | Wet parts | Batch (g) |
|---|---|---|---|---|
| (4) 7091 RV | 49.3 | 15.5 | 31.4 | 14.2 |
| (6) AF 540 | 55.17 | 34 | 61.6 | 27.8 |
| (7) PR 591 | 43.5 | 34 | 78.2 | 35.2 |
| (3) NMMO | 50 | 2.5 | 5.0 | 2.3 |
| (9) EDTA | 95 | 0.5 | 0.5 | 0.23 |
| (8) VS222 | 10 | 20 | 200.0 | 90.1 |
| (1) Sodium | 63.4 | 3 | 4.7 | 2.1 |
| Bicarbonate | | | | |
| (2) Urea | 95 | 5 | 5.3 | 2.4 |
| (5) Water | | | 572.7 | 258.1 |
| | Approx. 12% | 114.5 | 959.4 | 432.43 |
| | total solids | | | grams |
| | formulation | | | |

For the purposes of Example 1, components numbered 1, 2, and 3 were mixed together with ½ of the water to form a first solution. Then component 4 and the remainder of the water were mixed with components 6, 7, 8 and 9 to form a second solution. The second solution was applied first via padding and dried in a forced air oven at 100° C. and the first solution was placed on top via padding and also dried at 100° C.

The total solids content percentage was about 12. The dry pick up percentage was between about 9 and 10 percent for the above formulation. This was approximately 90-99 percent wet pick up. The speed of padding was between 15-60 feet per minute, although it was desirable to obtain a speed between 20-30 feet per minute, in pressure rolls of between 20-60 psig.

### EXAMPLE 2

In a second example, the coating formulation of Table 2 was added to cotton fabric as described below and dried at 100° C. under the same production conditions.

TABLE 2

| Component | % total solids | Dry Parts | Wet parts | Batch (g) |
|---|---|---|---|---|
| 7091 | 49.3 | 15.5 | 31.4 | 19.90 |
| AF 540 | 55.17 | 34 | 61.6 | 39.00 |
| PR 591 | 43.5 | 34 | 78.2 | 49.47 |
| NMMO | 50 | 2.5 | 5.0 | 3.16 |
| EDTA | 95 | 0.5 | 0.5 | 0.33 |
| VS 475 | 10 | 20 | 200.0 | 126.58 |
| Sodium | 63.4 | 7 | 11.0 | 6.99 |
| Bicarbonate | | | | |
| Urea | 95 | 5 | 5.3 | 3.33 |
| Water | | | 402.2 | 254.56 |
| | Approx. 15% | 118.5 | 795.2 | 503.32 |
| | total solids | | | |
| | formulation | | | |

Percent Pick-Up

Percent dry pickup is calculated in accordance with the following series of equations. These equations are described in Wellington Sears Handbook of Industrial Textiles, by Sabit Adanur, PH. D. copyright 1995, p.179.

$$Wet pickup ( \% ) = \frac{Weight of formulation picked up}{Weight of dry fabric} \times 100$$

Add-on (%)=Concentration of Formulation (%)×Wet Pickup (%)

From this the following equation was utilized to arrive at the values in the charts for % dry-pickup.
% Dry Pickup=((Wet treated fabric weight/Dry untreated fabric weight)×100)−100×treatment formulation % Solids (TS)

Color Measurements

Color measurement refers to the interpretation of the visual sensation of color in terms of three numbers that can be used to objectively assess and quantify differences in color between objects. Instruments are available that measure the spectrum of light reflected from the surface of an object and translate this spectrum into a series of numbers that pertain to visual color sensations. For instance, the subjective term ‘brightness’ may be quantified using the objective quantity ‘luminance’ obtained using a color measuring instrument. Color is measured by taking printed fabric, steaming the print if desired, allowing the print to cool and dry, and then offering the printed area to the head (manufactured by Hunter Associates Laboratory, Inc., 11491 Sunset Hills Road, Reston, Va. 22090.) using normal operating procedures as described by the manufacturer. As the fabric used was not entirely opaque, the sample was placed upon a standard white calibration tile (Hunter Associates Laboratory, Inc.) during measurement. As the visual sensation of color depends upon many things, including the type of light source (e.g., direct sunlight, tungsten filament light, etc.) used to view the object, as well as the amount of the observer's field of vision that the object occupies, these parameters must also be specified when measuring color. Colorimetric data were obtained using a D65 illuminant and 10 degree observer settings.

ΔE*, or magnitude change in color, is calculated in accordance with the following equation:
ΔE*=[(L*sample 1−L*sample 2)²+(a*sample 1−a*sample 2)²+(b*sample 1−b*sample2)²]^{0.5}

Larger ΔE* represents larger changes in color. Unless the color's intensity is increased by a curing step, a large increase in ΔE* would typically be indicative of fading. The testing was generally in accordance with ASTM DM 224-93 and ASTM E308-90. Where values for delta E* are less than 3.0, it is generally accepted that such color change cannot be observed with the human eye. A detailed description of spectrodensitometer/spectrophotometer testing is available in AATCC Technical Manual Vol 74, 1999, pages 369-375.

In the present invention, NMMO was incorporated into the fabric pretreatment combination solution (of both an imbibing and coating formulation) of Example 1 by padding (dip and squeeze methods). However, alternative methods for imbibing fabrics with such solutions include exhaustion, spraying, and air knife applications. The fabrics were then dried by an oven at the temperature previously described. Following the drying step, the fabrics were printed using a thermal ink jet printer (Yuhan-Kimberly model CMR) operating at speeds ranging from 2.5 m² per hour to 30 m² per hour and employing fiber reactive inks. Such inks are available from Formulabs, a Sensient Company, of San Diego, Calif. and are described generally in comparative examples in U.S. Pat. No. 6,451,098 B1.

The fabrics were color tested after printing to arrive at a value for the purposes of the above Delta E equation. Following this, the fabrics were washed and/or washed and steamed, as described below and color tested. It was observed that the colors on such fabrics appeared much more vivid/vibrant after washing or steaming. The following CIE L*a*b* measurements, were compared to fabrics that had been treated with the same combination coating but without NMMO, and that had also been exposed to both washing and steaming steps.

In order to make the samples that were tested, a coated paper-backed cotton poplin material (basis weight of 6.5 oz/sq.yd) 133×72 plain weave, was fed into the printer for printing and then printed. The paper included an adhesive and had been laminated to the material backing for processing through the printer. Specifically, the textile substrate had been laminated to an adhesive coated paper backing (which was obtained from American Builtrite, Inc. under the designation ProtecRite® 6798) prior to printing, to enable the substrate to be easily coursed through the printer. The substrates were then removed from the backing prior to washing. Adhesive coated backing papers identified by the designation 6798 include a paper having a nominal thickness of 5.4 ml, an initial adhesion value of 27 oz/in, a tensile strength of 16 lbs/in, and an elongation capability of 10%.

For visual comparison, two sample groups (aside from standards) of each color were printed, one with a coating including the NMMO of the present invention, the other without the NMMO coating of the current invention (but still including a coating formulation). The backing was removed from the printed fabric, and the fabric was steamed where noted, for 25 minutes at 100° C. using a Jacquard Vertical Steamer. The fabric samples were then washed as follows.

When washed, the samples were placed in an appropriate size beaker or container such as a one liter beaker. Samples were then placed under cold running water (between approximately 10-20° C.) for approximately two minutes. The cold water was then drained from the textile samples. The beakers were then refilled with hot water (between approximately 40-50° C.), and one ounce of detergent (Synthrapol® per gallon of water was added to the beakers).

The textile samples were then washed out for approximately five minutes and then rinsed and drained of remaining water. Finally, the textile samples were rinsed with warm water (of between approximately 25-30° C.) for two minutes followed by a rinse with cold water (of between approximately 10-20° C.) for approximately one more minute.

The cotton prints were compared visually and by color measurement as described below in Tables 4-6. The samples were air dried under ambient conditions for about 15-20 minutes after printing, and then cut into samples as described. The samples were then either washed or washed and/or steamed.

Reactive Red Ink Experiments

For reference purposes, Reactive Red ink was printed onto NMMO coated material (that is material coated with the coating of Example 1 described above), allowed to dry at ambient conditions for 30 minutes and the color measured. L*=35.46 a*=52.31 b*=2.05. The Reactive Red ink was then printed onto the non-NMMO coated material (the material coated with the coating of Example 1, but without the NMMO). The color coordinates for the Reactive Red ink printed onto non-NMMO treated substrate were similar to the previously described values, but were not recorded.

Samples were divided into two groupings. One portion was steamed then washed and dried at ambient conditions before the color was measured. A second sample was washed without steaming and allowed to air dry at ambient conditions before the color was measured.

TABLE 4

| NMMO Pre-treated fabric (of Example # | | | | |
|---|---|---|---|---|
| 1) | L* | a* | b* | ΔE* |
| Steamed and Washed | 36.85 | 50.11 | 1.00 | 3.60 |
| Washed | 36.13 | 53.46 | 2.09 | |
| Pre-treated fabric of Example # 1 without | | | | |
| NMMO: | L* | a* | b* | ΔE* |
| Steamed and Washed | 31.95 | 50.65 | 10.17 | 11.97 |
| Washed | 37.51 | 48.15 | −0.43 | |

Reactive Green Ink Experiments

For reference purposes, Reactive Green ink was printed onto NMMO coated material (that is material coated with the coating of Example 1 described above), allowed to dry at ambient conditions for 30 minutes and the color measured. L*=64.74 a*=−12.80 b*=62.02. The Reactive Green ink was then printed onto the non-NMMO coated material (that is material that was coated with the coating of Example 1, but without the NMMO). The color coordinates for the Reactive Green ink printed onto non-NMMO treated substrate were similar as those previously described for Reactive Green, but were not recorded.

Samples were divided into two groups. One portion was steamed then washed and dried at ambient conditions before the color was measured. A second sample was washed without steaming and allowed to air dry at ambient conditions before the color was measured.

TABLE 5

| NMMO Pre-treated fabric (of Example # | | | | |
|---|---|---|---|---|
| 1) | L* | a* | b* | ΔE* |
| Steamed and Washed | 64.71 | −20.92 | 65.68 | 2.57 |
| Washed | 67.27 | −20.88 | 65.85 | |
| Pre-treated fabric of Example # 1 without | | | | |
| NMMO: | L* | a* | b* | ΔE* |
| Steamed and Washed | 64.90 | −22.18 | 74.37 | 12.23 |
| Washed | 71.07 | −28.57 | 65.92 | |

Reactive Blue Ink Experiments

For reference purposes, Reactive Blue ink was printed onto NMMO coated material (as with the previous color ink examples), allowed to dry at ambient conditions for 30 minutes and the color measured. L*=37.00 a*=10.29 b*=−40.91. The color coordinates for the Reactive Blue ink printed onto non-NMMO treated substrate (coating without NMMO) were similar to the previous “Blue” values, however, these figures were not recorded.

Samples were divided into two groups. One portion was steamed then washed and dried at ambient conditions before the color was measured. A second sample was washed without steaming and allowed to air dry at ambient conditions before the color was measured.

TABLE 6

| NMMO Pre-treated fabric (of Example # | | | | |
|---|---|---|---|---|
| 1) | L* | a* | b* | ΔE* |
| Steamed and Washed | 31.94 | 13.05 | −45.26 | 7.59 |
| Washed | 38.79 | 11.06 | −47.86 | |
| Pre-treated fabric of Example # 1 without | | | | |
| NMMO: | L* | a* | b* | ΔE* |
| Steamed and Washed | 25.06 | 13.18 | −39.34 | 14.76 |
| Washed | 39.81 | 4.14 | −38.71 | |

Steaming may be used as an aftertreatment for dyes printed onto cotton. It is thought that the steam facilitates dye fixation at least in part, by opening the fiber structure to allow dye penetration and by providing energy to facilitate the reaction with the fiber. The color data from tests using Red, Green, and Blue Reactive dye-based ink show that the color difference between steamed and washed and washing before steaming are less, if NMMO is used, suggesting that less steaming may be required for fixation if NMMO is used in the fabric pre-treatment coating. For the samples tested it can therefore be seen that steaming is not necessary to cure the ink formulations, and the print itself. It should also be noted that the NMMO treated fabrics exhibited more color vibrancy/depth of color than the printed non-NMMO treated fabrics.

While the invention has been described in detail with particular reference to a preferred embodiment thereof, it should be understood that many modifications, additions and deletions can be made thereto without departure from the spirit and the scope of the invention as set forth in the following claims.

1. An aqueous substrate coating or imbibing solution for treating a substrate prior to printing, and for enhancing image visualization and retention of ink jet inks and comprising N-methylmorpholine-N-oxide.

2. An aqueous coating formulation containing solids, for enhancing image visualization and retention of ink-jet inks, comprising:
a) N-methylmorpholine-N-oxide
b) a cationic polymer or copolymer,
c) and a fabric softener.

3. The aqueous coating of claim 2 further containing urea.

4. The aqueous coating of claim 2 wherein said coating includes between about 0.05-10 percent total solids of N-methylmorpholine-N-oxide.

5. The aqueous coating of claim 4 wherein said coating includes between about 2 and 5 percent total solids N-methylmorpholine-N-oxide.

6. The aqueous coating of claim 2 wherein said coating includes between about 25-75 percent total solids cationic polymers or copolymers.

7. The aqueous coating of claim 6 wherein said coating includes between about 25 and 40 percent total solids cationic polymers or copolymers.

8. The aqueous coating of claim 2 wherein said coating includes between about 5 and 20 percent total solids fabric softeners.

9. The aqueous coating of claim 8 wherein said coating includes between about 10 and 20 percent total solids fabric softeners.

10. The aqueous coating of claim 2 further including a latex polymer.

11. The aqueous coating of claim 10 wherein said latex polymer is present in an amount of between about 0-50 percent total solids.

12. The aqueous coating of claim 2 wherein said total solids are present in an amount between about 10-50 percent.

13. The aqueous coating formulation of claim 2 further including urea.

14. The aqueous coating formulation of claim 13 wherein said urea is present in an amount of between about 0.05 and 7 percent total solids.

15. The aqueous coating formulation of claim 14 wherein said urea is present in an amount of between about 2 and 5 percent total solids.

16. The aqueous coating formulation of claim 2 further including a sequestering agent.

17. An aqueous coating formulation containing solids, for enhancing image visualization and retention of reactive dye-based inks, comprising:
a) N-methylmorpholine-N-oxide
b) a cationic polymer or copolymer,
c) a fabric softener,
d) urea, and
e) a component selected from sodium bicarbonate, sodium carbonate or combinations thereof.

18. The aqueous coating formulation of claim 17 wherein either the sodium bicarbonate, sodium carbonate, or combination thereof is present in an amount of between about 1-10 percent of the total solids.

19. An aqueous coating formulation containing solids, for enhancing image visualization and retention of reactive dye-based inks, comprising:
a) N-methylmorpholine-N-oxide
b) a cationic polymer or copolymer,
c) a fabric softener,
d) urea, and
e) ammonium salts of multifunctional weak acids.

20. The aqueous coating formulation of claim 19 wherein said ammonium salts are selected from the group consisting of ammonium oxalate, ammonium tartrate and ammonium sulfate.

21. The aqueous coating formulation of claim 20 wherein said ammonium salts are present in an amount of between about 0.1 and 5.0 percent total solids.

22. A method of treating a substrate so as to improve the adhesion, colorfastness and washfastness of an acid dye-based ink jet ink printed onto the substrate, and which substrate may be exposed to a post-treatment step following printing, including the steps of:
a) providing a substrate, and
b) pretreating the substrate with an aqueous coating formulation comprising N-methylmorpholine-N-oxide, a cationic polymer or copolymer, a fabric softener, urea, and an ammonium salt of multifunctional weak acids.

23. A method of producing a printed substrate so as to improve the adhesion, colorfastness and washfastness of an acid dye-based ink jet ink printed onto the substrate, including the steps of:
a) providing a substrate,
b) treating the substrate with an aqueous coating formulation comprising NMMO, a cationic polymer or copolymer, a fabric softener, urea, and either ammonium sulfate, oxalate or tartrate,
c) drying the substrate,
d) printing on the substrate with an acid dye-based ink, and
e) optionally post-treating the printed substrate.

24. A method of treating a substrate so as to improve the adhesion, colorfastness and washfastness of a reactive dye-based ink jet ink printed onto the substrate, and which substrate may be exposed to a post-treatment step following printing, which method includes the steps of:
a) providing a substrate, and
b) pretreating the substrate with an aqueous coating formulation comprising NMMO, a cationic polymer or copolymer, a fabric softener, urea, and either sodium bicarbonate, sodium carbonate or combination thereof.

25. A method of producing a printed substrate so as to improve the adhesion, colorfastness and washfastness of a reactive dye-based ink jet ink printed onto the substrate, including the steps of:
a) providing a substrate,
b) pretreating the substrate with an aqueous coating formulation comprising NMMO, a cationic polymer or copolymer, a fabric softener, urea, either sodium bicarbonate, sodium carbonate or combination,
c) drying the substrate,
d) printing on the substrate with a reactive dye-based ink, and
e) optionally post-treating the printed substrate.
